(19) United States
(12) Patent Application Publication
(10) Pub. No.: US 2025/0116262 A1
(43) Pub. Date: Apr. 10, 2025

(54) INTEGRATED ELECTRO-HYDRAULIC UNIT

(71) Applicant: Robert Bosch GmbH, Stuttgart (DE)

(72) Inventors: Enrique Busquets, Greer, SC (US); Andreas Guender, Lohr Am Main (DE)

(21) Appl. No.: 18/481,476

(22) Filed: Oct. 5, 2023

(51) Int. Cl. F04B 17/03; F04B 1/2035; H02K 1/27

(52) U.S. Cl. CPC F04B 17/03; F04B 1/2035; H02K 1/27

(57) ABSTRACT

An integrated electro-hydraulic unit including a stator, a shaft, and a cylinder block coupled to the shaft and configured to rotate around a central axis. The integrated electro-hydraulic unit includes a plurality of pistons received in the cylinder block. The plurality of pistons are configured to reciprocate with respect to the cylinder block in response to rotation of the cylinder block. The integrated electro-hydraulic unit includes a plurality of rotor magnets. The cylinder block includes a shaft aperture along the central axis configured to receive the shaft, a plurality of piston apertures each configured to receive a piston of the plurality of pistons, and a plurality of magnet apertures configured to receive the plurality of rotor magnets to form a rotor.

### FIELD OF THE INVENTION

The present disclosure relates to an electric and hydraulic machine. More particularly, the present disclosure relates to an integrated electro-hydraulic unit.

### BACKGROUND OF THE INVENTION

The present disclosure relates to an integrated electro-hydraulic unit. As is often the case, integrated electro-hydraulic units include a hydraulic machine and an electric machine. The hydraulic machine is responsible for interacting with a working fluid. The electric machine is responsible for inducing rotation of the hydraulic machine and/or recovering energy from the rotation of the hydraulic machine.

### SUMMARY OF THE INVENTION

The present invention provides, in one aspect, an integrated electro-hydraulic unit including a stator, a shaft, a cylinder block coupled to the shaft and configured to rotate around a central axis, and a plurality of pistons received in the cylinder block. The plurality of pistons are configured to reciprocate with respect to the cylinder block in response to rotation of the cylinder block. The integrated electro-hydraulic unit includes a plurality of rotor magnets. The cylinder block includes a shaft aperture along the central axis configured to receive the shaft, a plurality of piston apertures each configured to receive a piston of the plurality of pistons, and a plurality of magnet apertures configured to receive the plurality of rotor magnets to form a rotor.

The present invention provides, in another aspect, an integrated electro-hydraulic unit including a stator, a plurality of rotor magnets, a shaft, and a cylinder block coupled to the shaft and configured to rotate around a central axis. The cylinder block receives the plurality of rotor magnets. The integrated electro-hydraulic unit includes a plurality of pistons received in the cylinder block configured to reciprocate with respect to the cylinder block in response to rotation of the cylinder block. An air gap is defined by an outer surface of the cylinder block and the stator.

### BRIEF DESCRIPTION OF THE DRAWINGS

FIG. 1 illustrates a perspective view of an integrated electro-hydraulic unit.

FIG. 2 illustrates a longitudinal cross-section of the integrated electro-hydraulic unit taken along line 2-2 of FIG. 1.

FIG. 3 illustrates a rotor, a drive flange, a cylinder block, and a plurality of pistons of the longitudinal cross-section of FIG. 2.

FIG. 4 illustrates a longitudinal cross-section of an integrated electro-hydraulic unit according to an embodiment of the present disclosure.

FIG. 5 illustrates an end view of a cylinder block for the integrated electro-hydraulic unit of FIG. 4.

FIG. 6 illustrates a longitudinal cross-section of the cylinder block for the integrated electro-hydraulic unit taken along line 6-6 of FIG. 5.

### DETAILED DESCRIPTION

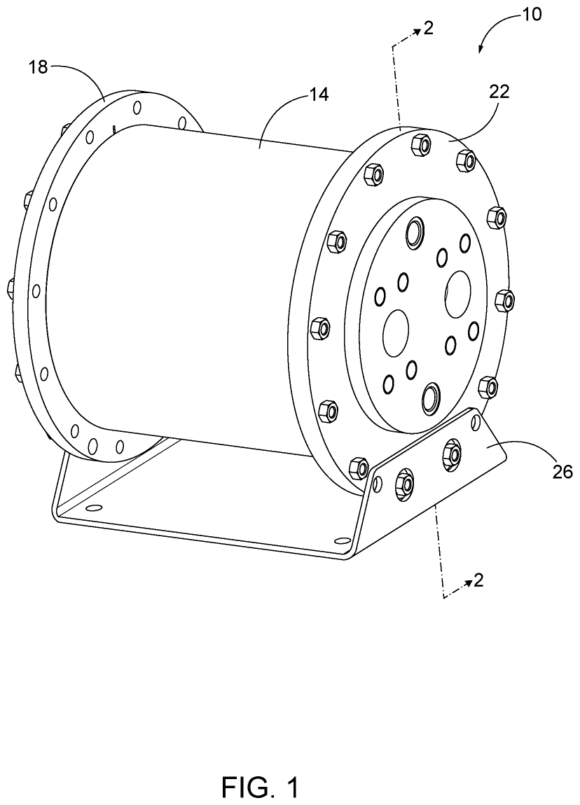

FIG. 1 illustrates an integrated electro-hydraulic unit 10. The integrated electro-hydraulic unit 10 includes a radial casing 14 disposed between a swashplate end case 18 and a porting end case 22. A mount 26 is coupled to the swashplate end case 18 and the porting end case 22.

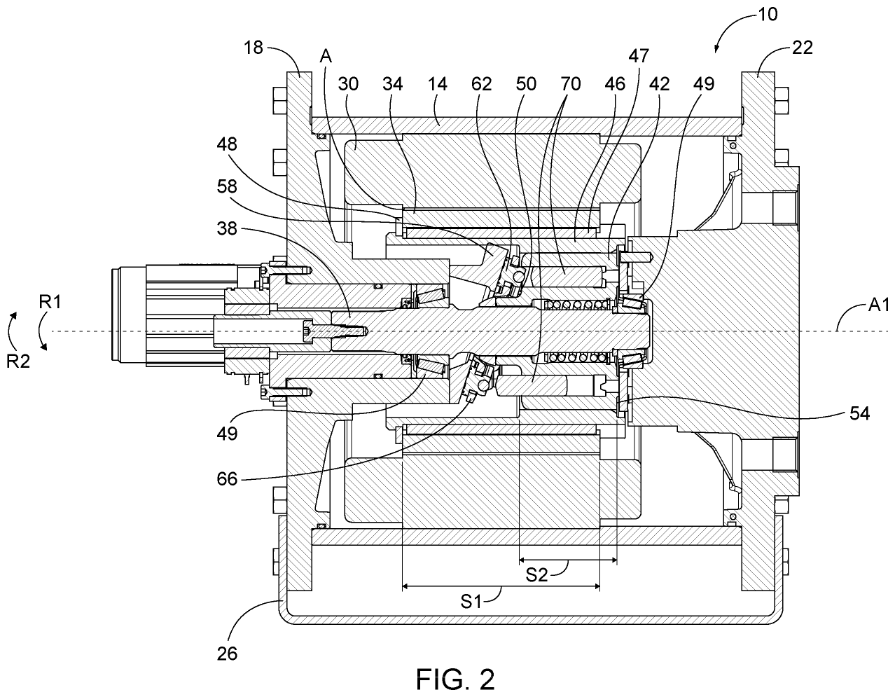

FIG. 2 illustrates the integrated electro-hydraulic unit 10 including an electric machine having a stator 30 and rotor 34. The stator 30 is located radially toward the radial casing 14 and the rotor 34 is located radially inward toward a central axis A1 from the stator 30. An air gap A is defined between the stator 30 and the rotor 34 to accommodate relative rotation of the rotor 34 during operation. The stator 30 is configured to induce rotation of the rotor 34 about the central axis A1 and/or recovering energy from the rotation of the rotor 34.

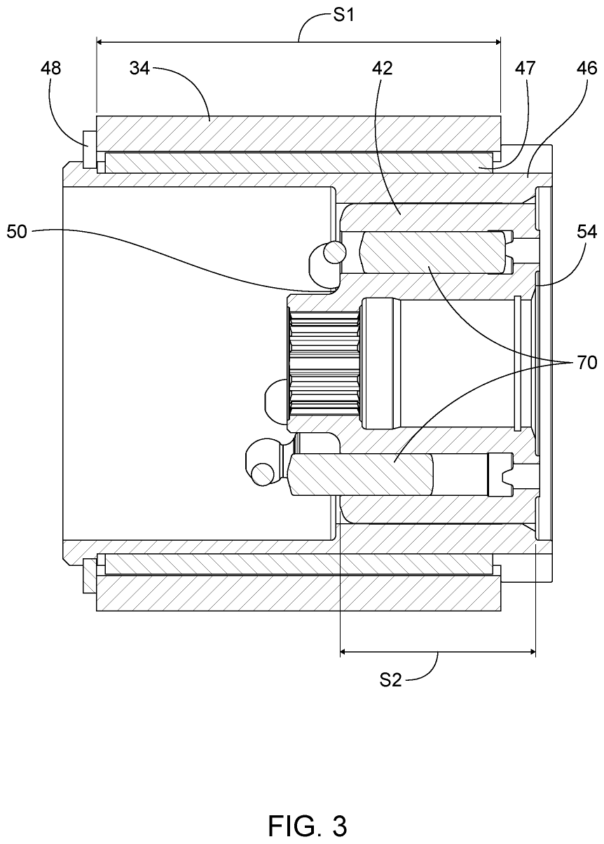

The integrated electro-hydraulic unit 10 includes a hydraulic machine having a shaft 38 extending along about the central axis A1 and a cylinder block 42 coupled to the shaft 38. The hydraulic machine includes a drive flange 46 disposed between the cylinder block 42 and the rotor 34. An axial span S1 of the rotor 34 and an axial span S2 of the cylinder block 42 are mismatched in size and/or position (e.g., the axial span S1 of the rotor 34 is greater than the axial span S2 of the cylinder block 42). As such, the drive flange 46 is provided as a radially interposed adapter, configured to transmit rotation between the rotor 34 and the cylinder block 42 (FIG. 3). The rotor 34 and the drive flange 46 are coupled for rotation via a key 47 and is axially secured via a ring 48. As described above, the rotation of the rotor 34 is induced by the stator 30 such that the drive flange 46 transmits the rotation to the cylinder block 42 such that the rotor 34, the drive flange 46, and the cylinder block 42 form a rotating assembly. The cylinder block 42 is rotatably supported by the shaft 38 about the axis A1 on bearings 49. The cylinder block 42 is rotatable about the axis A1 in a first rotational direction R1 and a second rotational direction R2. The cylinder block 42 has a first end 50 proximal to the swashplate end case 18 and a second end 54 proximal to the porting end case 22. The hydraulic machine includes a swashplate 58 located proximal to the first end 50 of the cylinder block 42, a plurality of slippers 62 in contact with the swashplate 58, and a retaining plate 66 to support the slippers 62 on the swashplate 58. The hydraulic machine further includes a plurality of pistons 70 coupled to the slippers 62 and received in the cylinder block 42 circumferentially about the axis A1. The pistons 70 are configured to reciprocate in the cylinder block 42 upon rotational movement of the cylinder block 42 about the axis A1 such that a working fluid (not shown) is pulled into and pushed out of the cylinder block 42. The cylinder block 42 is comprised of a uniform or monolithic construction to prevent leakage of the working fluid between the cylinder block 42 and the pistons 70. The monolithic construction of the cylinder block 42 also provides a durable surface to support the reciprocation of the pistons 70.

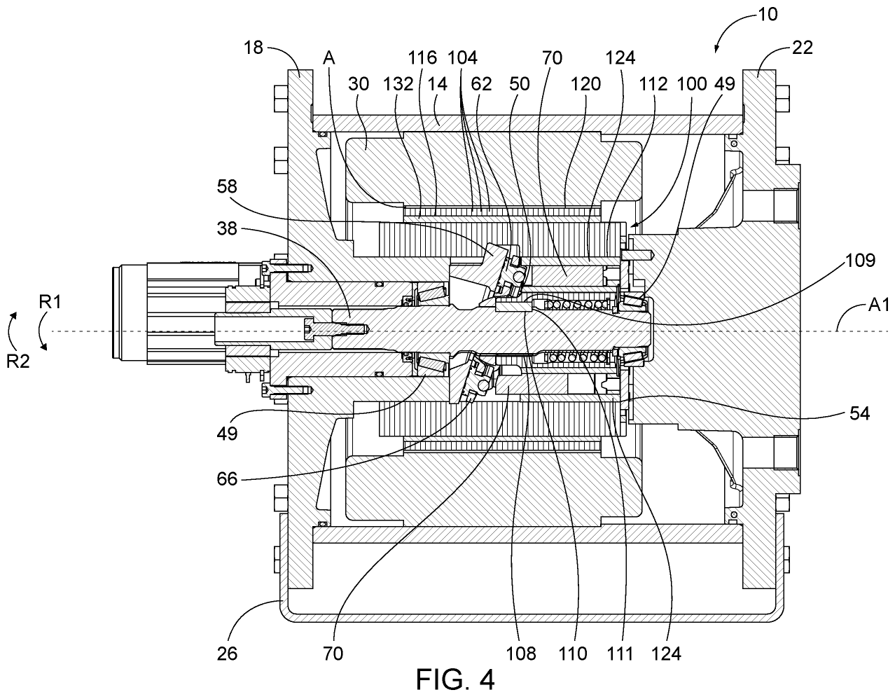

The integrated electro-hydraulic unit 10 shown in FIGS. 1-3 can be provided with any of the features and operations in accordance with the disclosures of Applicant's prior-filed U.S. patent application Ser. No. 18/348,752 and/or U.S. patent application Ser. No. 18/348,760, the entire contents of both of which are incorporated by reference herein. The remainder of the disclosure relates to an alternate cylinder block construction as shown in FIGS. 4-6.

FIGS. 4-6 illustrate a cylinder block 100 according to a construction of the present disclosure. The cylinder block 100 is compatible with the integrated electro-hydraulic unit 10 shown in the preceding drawings and described above. The cylinder block 100 replaces the rotating assembly (i.e., the rotor 34, the cylinder block 42, and the drive flange 46) because the cylinder block 100 incorporates a rotor as described further below. The consolidation of the rotor 34 into the cylinder block 100 decreases an outer diameter of the cylinder block 100 because the drive flange 46 is no longer needed. In some constructions, an inner diameter of the drive flange 46 is 95 millimeters, and an outer diameter is 120 millimeters. Therefore, removal of the drive flange 46 has the potential to reduce the outer diameter of the cylinder block 100 by 25 millimeters since the drive flange 46 is not needed. As such, the rotational inertia of the cylinder block 100 is reduced due to the decreased outer diameter compared to the rotating assembly. Due to the decreased outer diameter of the cylinder block 100, the stator 30 will require a smaller diameter to maintain the air gap A therebetween. The decrease in rotational inertia is substantial even with a reduction in the outer diameter because rotational inertial is exponentially related to diameter. The decreased diameter of the cylinder block 100 is not shown to scale in FIG. 4.

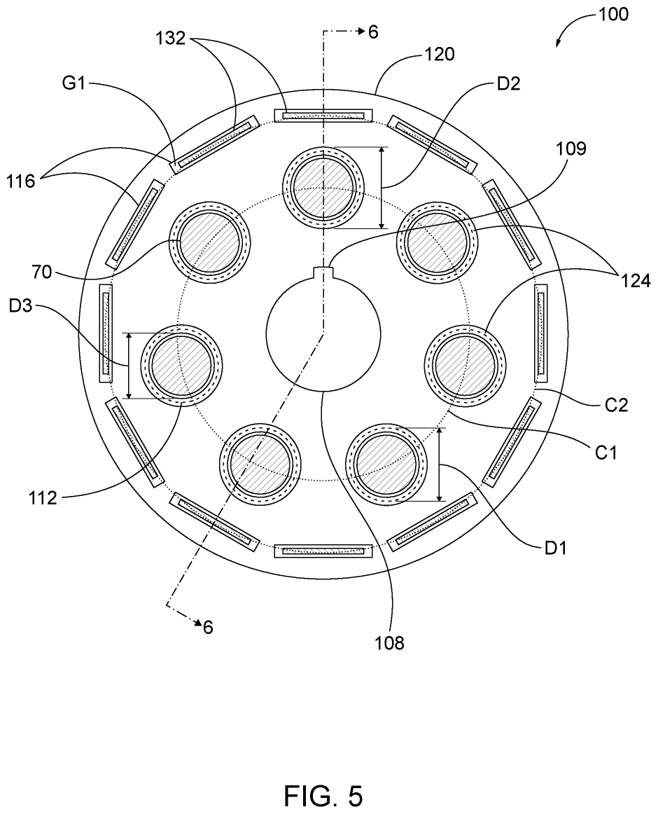

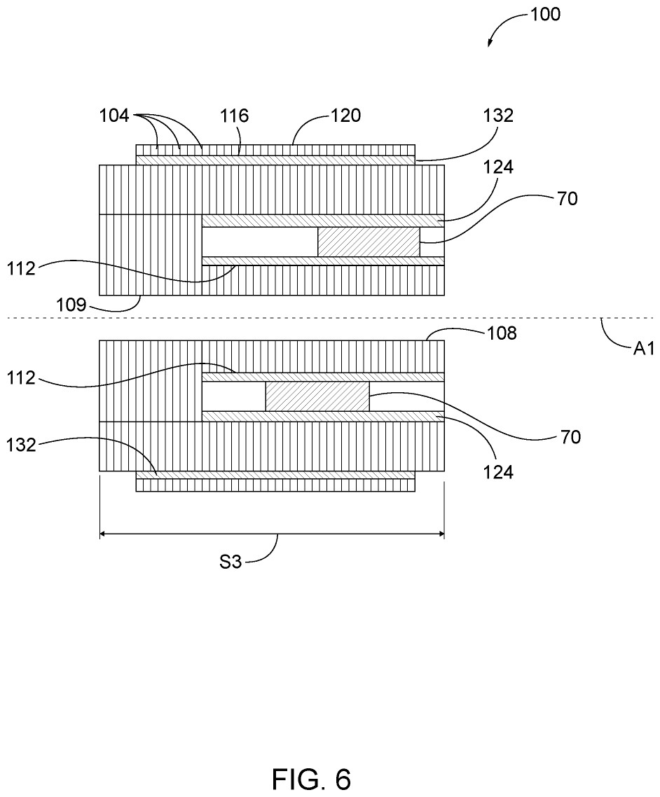

As shown in FIG. 4, the cylinder block 100 includes an outer surface 120 that is located radially adjacent to the stator 30 of the integrated electrohydraulic unit 10 to define the air gap A therebetween. The cylinder block 100 comprises a plurality of metal plates 104 (i.e., rotor laminations) stacked axially adjacent to one another along the axis A1 (FIG. 6). The metal plates 104 are constructed out of electrical steel (e.g., iron silicon alloy or silicon steel). The metal plates 104 have an axial thickness along the axis A1 of approximately 0.2 millimeters. In other constructions, the thickness is greater than or less than 0.2 millimeters. The metal plates 104 are coupled to one another via a bonding material (e.g., an epoxy) applied to each of the metal plates 104. In other constructions, the metal plates 104 are coupled together by interlocking, welding, and/or clamping. At least two of or all of the metal plates 104 are uniform in structure with one another. The cylinder block 100 includes a shaft aperture 108 axially aligned with the axis A1 and configured to receive the shaft 38. The shaft aperture 108 extends continuously through the cylinder block 100 and is symmetrical about the axis A1. The shaft aperture 108 of the cylinder block 100 includes a keyway 109 and the shaft 38 includes a keyseat 110 to receive a key 111 to couple the shaft 38 and the cylinder block 100 for rotation. The cylinder block 100 is configured to rotate around the central axis A1. In other constructions, the connection between the cylinder block 100 and the shaft 38 can be provided with any of the features and operations in accordance with the disclosures of German Patent Application No. 102007032138 and German Patent Application No. 102011121531, the entire contents of both of which are incorporated by reference herein. The cylinder block 100 includes a plurality of piston apertures 112 that are circumferentially distributed about the axis A1 (e.g., at even angular spacing intervals) and extend continuously through the cylinder block 100. Symmetry of the piston apertures 112 about the axis A1 ensures balance of the cylinder block 100 while rotating (FIG. 5). The plurality of piston apertures 112 are pre-formed in each of the plurality of metal plates 104 before the metal plates 104 are bonded together. The cylinder block 100 includes a plurality of magnet apertures 116 located most proximal to the outer surface 120 of the cylinder block 100. The magnet apertures 116 are pre-formed in each of the plurality of metal plates 104 before the metal plates 104 are bonded together. The magnet apertures 116 are circumferentially distributed about the axis A1 (e.g., at even angular spacing intervals) and extend continuously through the cylinder block 100. Symmetry of the magnet apertures 116 about the axis A1 ensures balance of the cylinder block 100 while. The piston apertures 112 are located radially inward toward the central axis A1 relative to the magnet apertures 116. The piston apertures 112 include a piston pitch circle diameter C1 and the magnet apertures 116 include a magnet pitch circle diameter C2 (FIG. 5). The pitch circle diameters C1, C2 are concentric about the central axis A1. The magnet pitch circle diameter C2 is larger than the piston pitch circle C1.

The piston apertures 112 in the cylinder block 100 are only rough apertures or piston bores, which are not configured to directly receive the pistons 70. As such, the cylinder block 100 receives a plurality of sleeves 124 (i.e., bushings) within the respective plurality of piston apertures 112. Each of the plurality of sleeves 124 is configured to directly receive a piston of the pistons 70. The piston apertures 112 include a piston aperture diameter D1 as shown with the dotted line. The sleeves 124 include an outer sleeve diameter D2 and an inner sleeve diameter D3. The outer sleeve diameter D2 is slightly larger than the piston aperture diameter D1 as exaggerated in FIG. 5. The sleeves 124 are press fit into the piston apertures 112 due to the difference in diameter between D1 and D2. Each sleeve 124 is press fit such that the entirety of the sleeve 124 is fixed within the piston apertures 112. The inner sleeve 124 diameter D3 is dimensioned such that an inner surface of the sleeves 124 slidably and sealingly supports the pistons 70. The pistons 70 are configured to slidably reciprocate with respect to the cylinder block 100 upon rotational movement of the cylinder block 100 about A1. The sleeves 124 extend through the entirety of the piston apertures 112 and are comprised of a uniform or monolithic construction as opposed to the laminated construction of the block 100. The sleeves 124 prevent leakage of the working fluid between the sleeves 124 and the pistons 70. The monolithic construction of the sleeves 124 provides a durable surface to support the reciprocation of the pistons 70 and maintain the fluid seal therebetween. The sleeves 124 may be comprised of a metal, a polymer, or another material.

The cylinder block 100 includes a plurality of rotor magnets 132 directly received within the magnet apertures 116. The magnets 132 are permanent magnets configured to interact with the stator 30 according to conventional principles. The magnets 132 extend through the entirety of the cylinder block 100 in the illustrated construction. The magnets 132 are sized to fit within the magnet apertures 116 with a clearance gap G1 therebetween to accommodate glue as exaggerated in FIG. 5. The glue in the clearance gap G1 bonds the magnets 132 within the magnet apertures 116, respectively. The glue may be applied to the magnets 132 prior to insertion into the magnet apertures 116. In some constructions, the glue may be applied to the magnet apertures 116 prior to insertion of the magnets 132. In some constructions, the magnets 132 are coupled to the cylinder block 100 via an interference fit (e.g., without glue). In other constructions, the connection between the magnets 132 and the cylinder block 100 can be provided with any of the features and operations in accordance with the disclosures of German Patent Application No. 102007032138 and German Patent Application No. 102011121531. In some constructions, the magnet apertures 116 include projections or rounded peaks that deform to receive the magnets 132.

What is claimed is:

1. An integrated electro-hydraulic unit comprising:
a stator;
a shaft;
a cylinder block coupled to the shaft and configured to rotate around a central axis;
a plurality of pistons received in the cylinder block, the plurality of pistons configured to reciprocate with respect to the cylinder block in response to rotation of the cylinder block; and
a plurality of rotor magnets,
wherein the cylinder block includes a shaft aperture along the central axis configured to receive the shaft, a plurality of piston apertures each configured to receive a piston of the plurality of pistons, and a plurality of magnet apertures configured to receive the plurality of rotor magnets to form a rotor.

2. The integrated electro-hydraulic unit of claim 1, wherein the cylinder block comprises a plurality of stacked metal plates.

3. The integrated electro-hydraulic unit of claim 2, wherein at least two of the plurality of stacked metal plates are uniform in structure with one another.

4. The integrated electro-hydraulic unit of claim 1, further comprising a plurality of sleeves received within the plurality of piston apertures, wherein each of the plurality of sleeves directly receives a piston of the plurality of pistons.

5. The integrated electro-hydraulic unit of claim 4, wherein each of the plurality of sleeves includes an outer sleeve diameter and each of the plurality of piston apertures includes a diameter, wherein the outer sleeve diameter is larger than the diameter of the plurality of piston apertures.

6. The integrated electro-hydraulic unit of claim 4, wherein each of the plurality of sleeves extends continuously through a corresponding one of the plurality of piston apertures.

7. The integrated electro-hydraulic unit of claim 1, wherein the shaft aperture, the plurality of piston apertures, and the plurality of magnet apertures extend continuously through the cylinder block.

8. The integrated electro-hydraulic unit of claim 7, wherein each of the plurality of rotor magnets extends continuously through a corresponding one of the plurality of magnet apertures.

9. The integrated electro-hydraulic unit of claim 1, wherein the shaft aperture, the plurality of piston apertures, and the plurality of magnet apertures are disposed symmetrically about the central axis.

10. The integrated electro-hydraulic unit of claim 1, wherein the plurality of piston apertures includes a piston pitch circle diameter, and the plurality of magnet apertures includes a magnet pitch circle diameter, wherein the magnet pitch circle diameter is larger than the piston pitch circle diameter.

11. The integrated electro-hydraulic unit of claim 1, wherein each of the plurality of rotor magnets is a permanent magnet.

12. The integrated electro-hydraulic unit of claim 1, wherein each of the plurality of rotor magnets is coupled to the plurality of magnet apertures via glue.

13. The integrated electro-hydraulic unit of claim 1, further comprising a gap disposed between each of the plurality of rotor magnets and a corresponding one of the plurality of magnet apertures, wherein each gap accommodates glue that bonds the rotor magnet in the corresponding magnet aperture.

14. An integrated electro-hydraulic unit comprising:
a stator;
a plurality of rotor magnets;
a shaft;
a cylinder block coupled to the shaft and configured to rotate around a central axis, the cylinder block receiving the plurality of rotor magnets; and
a plurality of pistons received in the cylinder block, the plurality of pistons configured to reciprocate with respect to the cylinder block in response to rotation of the cylinder block,
wherein an air gap is defined by an outer surface of the cylinder block and the stator.

15. The integrated electro-hydraulic unit of claim 14, wherein the cylinder block includes a shaft aperture along the central axis configured to receive the shaft, the shaft aperture including a keyway.

16. The integrated electro-hydraulic unit of claim 14, wherein the cylinder block comprises a plurality of stacked metal plates.

17. The integrated electro-hydraulic unit of claim 14, wherein the cylinder block includes a shaft aperture along the central axis configured to receive the shaft, a plurality of piston apertures each configured to receive a piston of the plurality of pistons, and a plurality of magnet apertures configured to receive the plurality of rotor magnets to form a rotor.

18. The integrated electro-hydraulic unit of claim 17,
wherein the shaft aperture, the plurality of piston apertures, and the plurality of magnet apertures are disposed symmetrically about the central axis,
wherein the plurality of piston apertures includes a piston pitch circle diameter and the plurality of magnet apertures includes a magnet pitch circle diameter,
and wherein the magnet pitch circle diameter is larger than the piston pitch circle diameter.

19. The integrated electro-hydraulic unit of claim 17, wherein the shaft aperture, the plurality of piston apertures, and the plurality of magnet apertures extend continuously through the cylinder block.

20. The integrated electro-hydraulic unit of claim 14, wherein each of the plurality of rotor magnets is coupled to the cylinder block via an interference fit.
